(19) United States
(12) Patent Application Publication
(10) Pub. No.: US 2019/0245313 A1
(43) Pub. Date: Aug. 8, 2019

(54) COAXIAL FITTING TOOL ASSEMBLY

(71) Applicant: Bruce Leon Odom, Weatherford, TX (US)

(72) Inventor: Bruce Leon Odom, Weatherford, TX (US)

(21) Appl. No.: 15/890,878

(22) Filed: Feb. 7, 2018

(51) Int. Cl. H01R 43/22; B25B 13/50; B25G 1/00

(52) U.S. Cl. CPC H01R 43/22; B25B 13/461; B25G 1/005; B25B 13/50

(57) ABSTRACT

A coaxial fitting tool assembly for tightening or loosening a coaxial fitting includes a tool that may engage a fitting on a coaxial cable thereby facilitating the fitting to be loosened or tightened. A bar is selectively extended through the tool and the bar is selectively manipulated. The bar rotates the tool thereby facilitating the fitting to be tightened or loosened.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to tool devices and more particularly pertains to a new tool device for coaxial fitting.

### (h) BRIEF SUMMARY OF THE INVENTION

An embodiment of the disclosure meets the needs presented above by generally comprising a tool that may engage a fitting on a coaxial cable thereby facilitating the fitting to be loosened or tightened. A bar is selectively extended through the tool and the bar is selectively manipulated. The bar rotates the tool thereby facilitating the fitting to be tightened or loosened.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a coaxial fitting tool assembly according to an embodiment of the disclosure.

FIG. 2 is a bottom view of an embodiment of the disclosure.

FIG. 3 is a left side view of an embodiment of the disclosure.

FIG. 4 is a back view of an embodiment of the disclosure.

FIG. 5 is a front view of an embodiment of the disclosure.

FIG. 6 is a perspective view of an embodiment of the disclosure.

FIG. 7 is a perspective in-use view of an embodiment of the disclosure.

### (j) DETAILED DESCRIPTION OF THE INVENTION

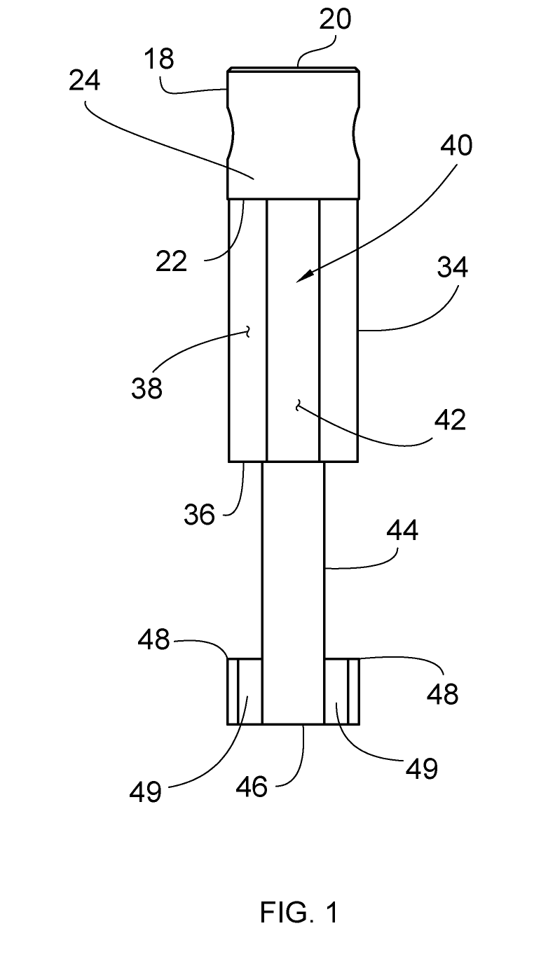

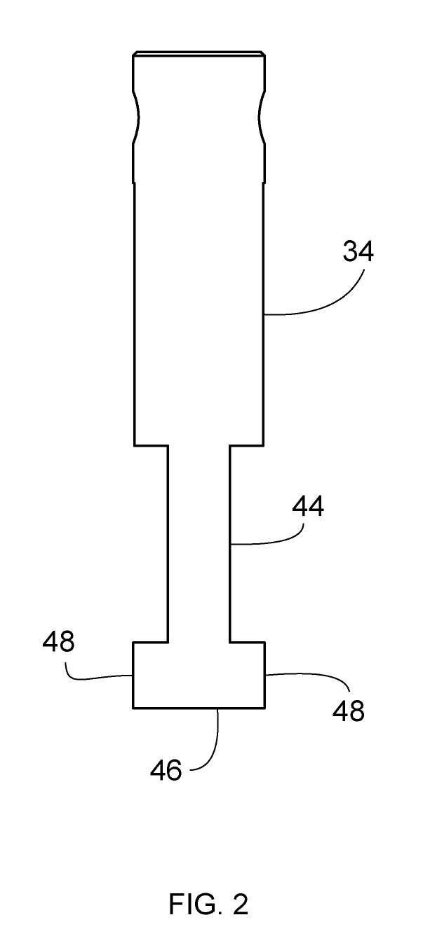

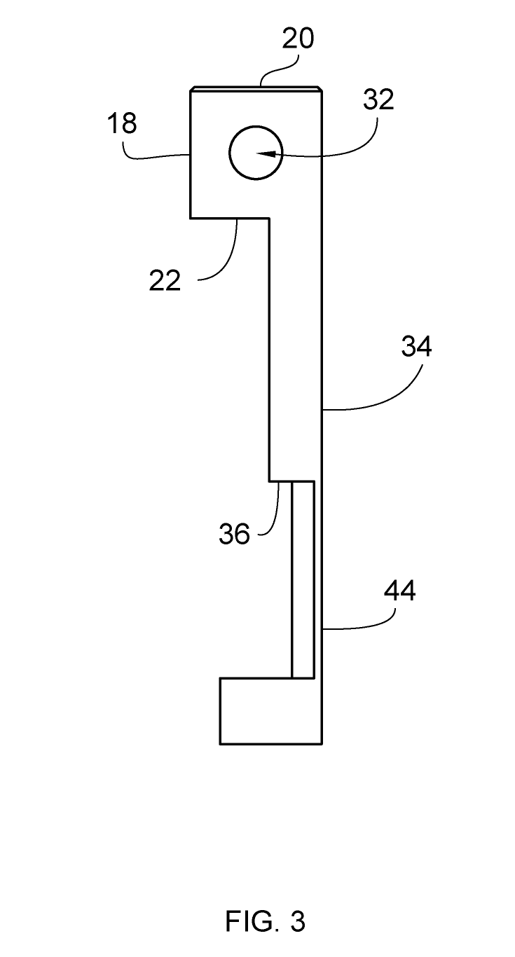

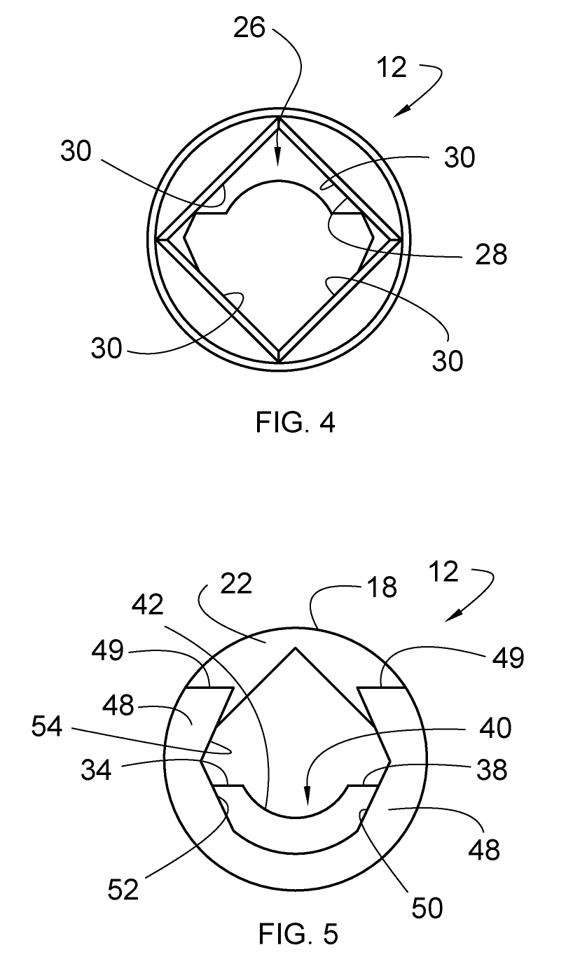

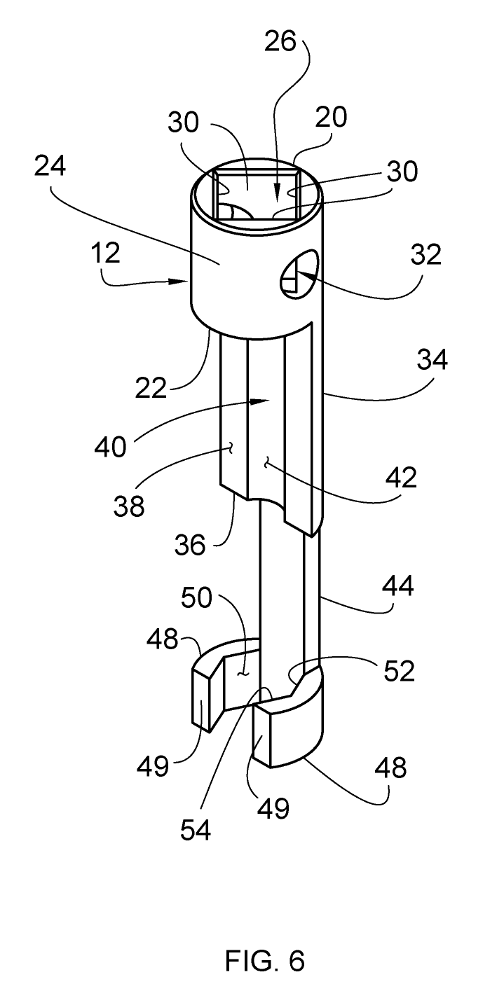

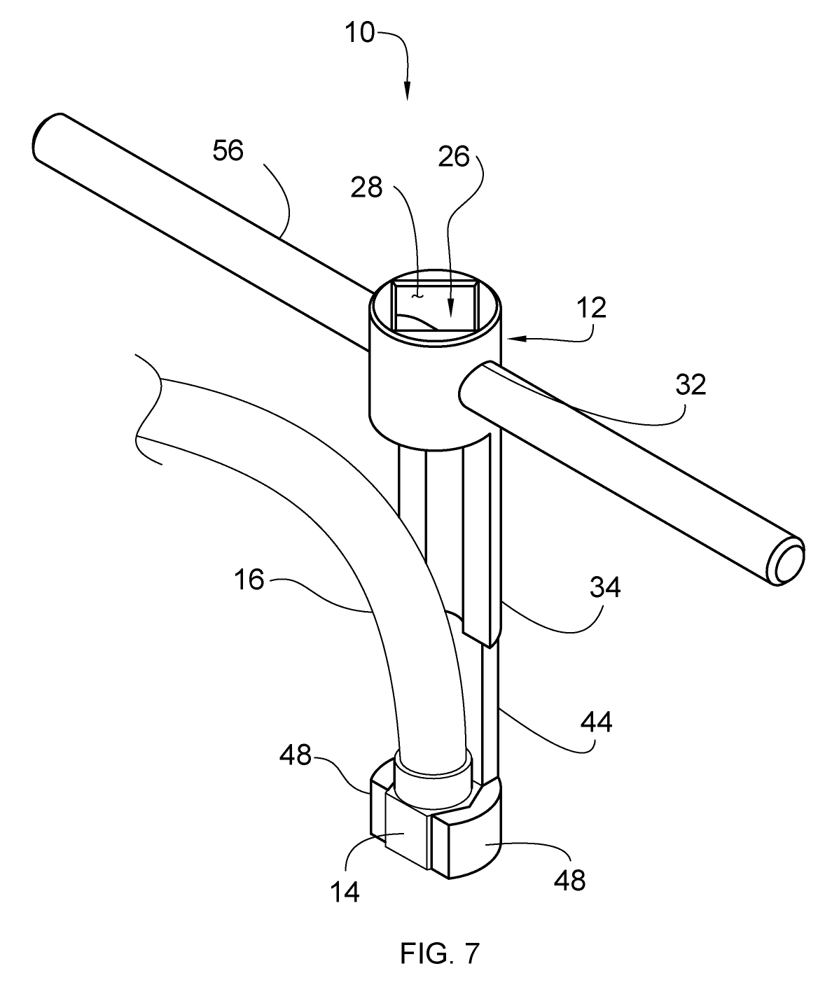

With reference now to the drawings, and in particular to FIGS. 1 through 7 thereof, a new tool device embodying the principles and concepts of an embodiment of the disclosure and generally designated by the reference numeral 10 will be described.

As best illustrated in FIGS. 1 through 7, the coaxial fitting tool assembly 10 generally comprises a tool 12 for engage a fitting 14 on a coaxial cable 16. The tool 12 facilitates the fitting 14 to be loosened or tightened. The coaxial cable 16 may be RG-6 or the like. Additionally, the fitting 14 may be a male F-type coaxial fitting 14 or the like.

The tool 12 comprises a cylinder 18 that has a first end 20, a second end 22 and an outer wall 24 extending therebetween. The cylinder 18 has an aperture 26 extending through the first end 20 and the second end 22 and the aperture 26 has a bounding surface 28. The bounding surface 28 as a plurality of intersecting sides 30 such that the aperture 26 has a square shape. Thus, the aperture 26 may receive a ⅜ inch ratcheting wrench or the like for rotating the tool 12. Additionally, the outer wall 24 has an opening 32 extending laterally through the cylinder 18 and the opening 32 is centrally positioned between the first end 20 and the second end 22.

A trough 34 is coupled to and extends away from the second end 22 of the cylinder 18. The trough 34 has a distal end 36 with respect to the cylinder 18 and a top surface 38 extending between the cylinder 18 and the distal end 36. The top surface 38 has a groove 40 extending downwardly therein and the groove 40 extends between the cylinder 18 and the distal end 36. Moreover, the groove 40 has a bounding surface 42 and the bounding surface 42 is concavely arcuate with respect to the top surface 38. In this way the groove 40 is accommodates and receives the coaxial cable 16.

A member 44 is coupled to and extends away from the distal end 36 of the trough 34 and the member 44 is oriented co-linear with the trough 34. The member 44 has a distal end 46 with respect to the trough 34 and the member 44 is spaced downwardly from the bounding surface 42 of the groove 40. The tool 12 includes a pair of grips 48 and each of the grips 48 is coupled to and extends upwardly from the member 44. Moreover, the grips 48 are spaced apart from each other on the member 44.

Each of the grips 48 has a distal end 49 with respect to the member 44 and an inwardly facing surface 50. Each of the grips 48 curves inwardly between the member 44 and the distal end 49 of each of the grips 48. The inwardly facing surface 50 corresponding to each of the grips 48 faces each other. Moreover, the inwardly facing surface 50 corresponding to each of the grips 48 has a first section 52 and a second section 54. The first section 52 of the inwardly facing surface 50 corresponding to each of the grips 48 is oriented at an obtuse angle with the second section 54 of the inwardly facing surface 50 of the corresponding grip. Thus, the inwardly facing surface 50 corresponding to each of the grips 48 may engage the fitting 14 on the coaxial cable 16 for rotating the fitting 14.

A bar 56 is provided and the bar 56 is selectively extended through the tool 12. The bar 56 rotates the tool 12 thereby facilitating the fitting 14 to be tightened or loosened. Additionally, the bar 56 is extendable through the opening 32 in the cylinder 18. The bar 56 may have a length ranging between approximately 15.0 cm and 30.0 cm.

In use, the tool 12 positioned on the coaxial cable 16 such that the grips 48 are spaced from the fitting 14 on the coaxial cable 16. The tool 12 is slid along the coaxial cable 16 such that each of the grips 48 engages the fitting 14. The bar 56 is slid through the opening 32 in the cylinder 18 and the bar 56 is manipulated to rotate the fitting 14 in a counterclockwise direction to loosen the fitting 14 or a clockwise direction to tighten the fitting 14. Additionally, the ratcheting wrench may be inserted into the aperture 26 in the cylinder 18 to provide additional rotational torque if the fitting 14 is too tight to be loosened with the bar 56. The tool 12 is removed from the coaxial cable 16 when the fitting 14 has been loosened or tightened.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A coaxial fitting tool assembly being configured to engage a fitting on a coaxial cable for tightening and loosening the fitting, said assembly comprising:
a tool being configured to engage a fitting on a coaxial cable thereby facilitating the fitting to be loosened or tightened; and
a bar being selectively extended through said tool wherein said bar is configured to be manipulated, said bar rotating said tool thereby facilitating the fitting to be tightened or loosened.

2. The assembly according to claim 1, wherein said tool comprises a cylinder having a first end, a second end and an outer wall extending therebetween, said cylinder having an aperture extending through said first end and said second end.

3. The assembly according to claim 2, wherein said aperture has a bounding surface, said bounding surface having a plurality of intersecting sides such that said aperture has a square shape wherein said aperture is configured to receive a ratcheting wrench.

4. The assembly according to claim 3, wherein said outer wall has an opening extending laterally through said cylinder, said opening being centrally positioned between said first end and said second end.

5. The assembly according to claim 2, wherein said tool includes a trough being coupled to and extending away from said second end of said cylinder, said trough having a distal end with respect to said cylinder and a top surface extending between said cylinder and said distal end.

6. The assembly according to claim 5, wherein said top surface has a groove extending downwardly therein, said groove extending between said cylinder and said distal end, said groove having a bounding surface, said bounding surface being concavely arcuate with respect to said top surface wherein said groove is configured to receive the coaxial cable.

7. The assembly according to claim 6, further comprising a member being coupled to and extending away from said distal end of said trough such that said member is oriented co-linear with said trough, said member having a distal end with respect to said trough, said member being spaced downwardly from said bounding surface of said groove.

8. The assembly according to claim 7, further comprising a pair of grips, each of said grips being coupled to and extending upwardly from said member, said grips being spaced apart from each other on said member, each of said grips having a distal end with respect to said member and an inwardly facing surface, each of said grips curving inwardly between said member and said distal end of each of said grips, said inwardly facing surface corresponding to each of said grips facing each other.

9. The assembly according to claim 8, wherein said inwardly facing surface corresponding to each of said grips has a first section and a second section, said first section of said inwardly facing surface corresponding to each of said grips being oriented at an obtuse angle with said second section of said inwardly facing surface of said corresponding grip wherein said inwardly facing surface corresponding to each of said grips is configured to engage the fitting on the coaxial cable.

10. The assembly according to claim 4, wherein said bar is extendable through said opening in said cylinder.

11. A coaxial fitting tool assembly being configured to engage a fitting on a coaxial cable for tightening and loosening the fitting, said assembly comprising:
a tool being configured to engage a fitting on a coaxial cable thereby facilitating the fitting to be loosened or tightened, said tool comprising:
a cylinder having a first end, a second end and an outer wall extending therebetween, said cylinder having an aperture extending through said first end and said second end, said aperture having a bounding surface, said bounding surface having a plurality of intersecting sides such that said aperture has a square shape wherein said aperture is configured to receive a ratcheting wrench, said outer wall having an opening extending laterally through said cylinder, said opening being centrally positioned between said first end and said second end;
a trough being coupled to and extending away from said second end of said cylinder, said trough having a distal end with respect to said cylinder and a top surface extending between said cylinder and said distal end, said top surface having a groove extending downwardly therein, said groove extending between said cylinder and said distal end, said groove having a bounding surface, said bounding surface being concavely arcuate with respect to said top surface wherein said groove is configured to receive the coaxial cable;
a member being coupled to and extending away from said distal end of said trough such that said member is oriented co-linear with said trough, said member having a distal end with respect to said trough, said member being spaced downwardly from said bounding surface of said groove; and
a pair of grips, each of said grips being coupled to and extending upwardly from said member, said grips being spaced apart from each other on said member, each of said grips having a distal end with respect to said member and an inwardly facing surface, each of said grips curving inwardly between said member and said distal end of each of said grips, said inwardly facing surface corresponding to each of said grips facing each other, said inwardly facing surface corresponding to each of said grips having a first section and a second section, said first section of said inwardly facing surface corresponding to each of said grips being oriented at an obtuse angle with said second section of said inwardly facing surface of said corresponding grip wherein said inwardly facing surface corresponding to each of said grips is configured to engage the fitting on the coaxial cable; and
a bar being selectively extended through said tool wherein said bar is configured to be manipulated, said bar rotating said tool thereby facilitating the fitting to be tightened or loosened, said bar being extendable through said opening in said cylinder.
